(19) United States
(12) Patent Application Publication
(10) Pub. No.: US 2019/0297655 A1
(43) Pub. Date: Sep. 26, 2019

(54) LOCAL BREAK-OUT IN MOBILE IP NETWORKS

(71) Applicant: Telefonaktiebolaget LM Ericsson (publ), Stockholm (SE)

(72) Inventors: Fredrik Garneij, Goteborg (SE); Jan Backman, Karna (SE)

(21) Appl. No.: 16/302,638

(22) PCT Filed: May 18, 2017
(86) PCT No.: PCT/EP2017/062038

§ 371 Date: Nov. 17, 2018

Related U.S. Application Data
(60) Provisional application No. 62/337,974, filed on May 18, 2016.

(51) Int. Cl. H04W 76/12; H04W 8/08; H04L 29/12; H04W 12/06

(52) U.S. Cl. CPC H04W 76/12; H04W 8/082; H04W 80/04; H04W 12/06; H04L 61/6059; H04L 61/2007

(57) ABSTRACT

A terminal, a radio access node, a first user plane node connecting to a first external network, a second user plane node connecting to a second external network, a control plane node for controlling the first and the second user plane nodes are disclosed. The system is adapted for configuring a first IPv6 prefix and a second IPv6 prefix, forwarding IP traffic stemming from the first IPv6 prefix in the second user plane node towards the first user plane node and further towards the first external network, and breaking out IP traffic stemming from the second IPv6 prefix in the second user plane node towards the second external network.

### TECHNICAL FIELD

This invention is directed to packet core functionality in mobile networks.

### BACKGROUND

In present the Evolved Packet Core, EPC, networks for mobile telephony, the so-called Access Point Name, has functioned as a “selector”, that can indicate a content delivery network.

In FIG. 1, there is shown an Evolved Packet Core Network according to 3GPP TS 23.401 V11.11.0 (2014-12)—FIG. 4.2.1-1, Non-roaming architecture for 3GPP accesses—showing a centrally located IP anchor (IP connectivity access point) in the PGW. The network is based on using IPv4 (Internet Protocol version 4) addresses.

In FIG. 2, a user entity, UE, is illustrated in the above 3GPP network that make use of various IP addresses for various applications running under the operative system of the user entity. IMS applications may use an IP (Internet Protocol) address U, while SMS (Short Message Services)/MMS (Multimedia Message Services) applications may use an IP address P, while still other application uses an IP address Q. Traffic related to the IMS may be communicated via one node while traffic related to other applications may be communicated via another node. The knowledge as to where and by which route traffic is communicated is application dependent. Consequently, should one wish to direct communication via specific routes applications need to be updated accordingly.

Recently, requirements for offering among others low latency and local services depending on the location of the user entity have been highlighted. One such model which allow for connectivity to services or peering points that is closer to the radio base station, is e.g. MEC, Mobile Edge Computing.

### SUMMARY

Existing solutions have some shortcomings with routing of traffic. If one uses one and the same IP address in a central IP access point (the PGW), there will be issues or restrictions with IP routing solutions. One disadvantage is that it is not possible to allocate new IP addresses during operation. By way of example and reference to FIG. 2, tunnels are statically arranged having a given end point in an IP anchor in the PGW.

If the address is routable to a common network (e.g. the Internet) from both the central as well as a distributed breakout-site there will be issues with triangular routing, i.e. traffic leaves the network at one site and the return traffic enters the network at another site, as the external network does not know which traffic is handled on which site. This implies that many standard actions cannot be handled such as firewalling.

To handle the problems with triangular routing it is often proposed that the break-out site instead should perform Network Address Translation, NAT, for the traffic itself or that it shall not be connected to the same external network. This will on the other hand put restrictions on what use-cases the solution can address.

It is a first object of the invention to set forth an improved system for routing packet data in mobile networks.

This object has been accomplished by a system comprising a user plane for routing and transporting payload data and a control plane. The system comprises a terminal, a radio access node, a first user plane node connecting to a first external network, a second user plane node connecting to a second external network, a control plane node for controlling the first and the second user plane nodes, and is adapted for
configuring a first IPv6 prefix and a second IPv6 prefix,
forwarding IP traffic stemming from the first IPv6 prefix in the second user plane node towards the first user plane node and further to-wards the first external network,
breaking out IP traffic stemming from the second IPv6 prefix in the second user plane node towards the second external network. It is further object to set forth methods and apparatuses.

According to embodiments of the invention there is also provided:

A User plane node being adapted for
forwarding IP traffic stemming from the first IPv6 prefix in the second user plane node towards the first user plane node and further to-wards the first external network,
breaking out IP traffic stemming from the second IPv6 prefix in the second user plane node towards the second external network.

A Terminal on which at least an application is running, the terminal being adapted for
receiving a router advertisement from a first node including a first IPv6 address,
adding the IPv6 prefix,
adding the announced routes to a routing table.

For an application in the terminal, the application is
opening a new TCP socket and matching a remote address towards a route with an IP address in a first external network.

A Control plane node adapted for
triggering a configuration of the second user plane node,
   when the control plane node is
triggering a configuration of the second user plane node,

Moreover, various methods for the respective nodes and systems above are provided.

Hence, according to embodiments of the invention not only is the terminal provided with one, but with (at least) two, IPv6 prefixes. One prefix is defining a central IP anchor point in the network while another prefix is defined for a decentralized/local site in the network. Breakout traffic is undertaken for the local site.

According to some embodiments of the invention, breakout of traffic is handled by advertising the two separate IPv6 prefixes for the central site and the breakout site respectively. According to solutions described in RFC 4191, one can also specify what traffic to route to the respective site by as an example routing all traffic to the central site, but traffic targeting specific prefixes that are routed to the local site.

As the local site may change with mobility of the device, the local based services will lose connectivity to the device (as the IP prefix need to change) as the device moves in the network.

One advantage of some of the embodiments of the present invention is that they are based on IPv6 (Internet Protocol version 6) as the Network renumbering scheme that is defined by IETF in RFC 4192. Support for this functionality exists in many operating systems, e.g. Linux on which Android is based on. Most IPv6 (Internet Protocol version 6) implementations are supporting this scheme.

Another advantage is that only one PDN (Packet data Network) connection is needed from the terminal side which lead to a decrease of the signalling in the network. Yet another advantage is that the network can decide when to stop supporting the old IP address based on a subscription policy. This can for instance be done based on inactivity or based on other operator defined policies (e.g. immediately if the operator so decides based on the business-case for that specific type of subscription).

Another advantage of some of present embodiments of the invention is that the anchor of the mobile session can be moved in network without impacting the signalling towards the terminal. This can for instance be used for scaling of the user plane or to allow for an operator controlled optimization of the network based on network element load, link utilization or other properties that the terminal typically would not have any knowledge of (and likely should not have either). Another such property might be that the network instance, the terminal is utilizing, needs to be brought down for maintenance or software upgrade.

### BRIEF DESCRIPTION OF THE DRAWINGS

FIG. 1 shows a prior art LTE network,

FIG. 2 shows a user entity of an exemplary LTE prior art solution,

FIG. 3 shows a mobile network according to an embodiment of the invention,

FIG. 4 shows a first embodiment of a method according to the invention for establishing a local break-out point,

FIG. 5a shows a second embodiment of a method according to the invention for performing mobility controlled move and tear down of a local break-out point,

FIG. 5b shows further steps of the method shown in FIG. 5a,

FIG. 6a shows an alternative embodiment to the one shown in FIG. 5a+b, comprising fault handling mechanisms,

FIG. 6b shows further steps of the method shown in FIG. 6a,

FIG. 7 shows a radios access node, a control plane node and a user plane node, and

FIG. 8 shows further implementation details of a further embodiment of the invention.

### DETAILED DESCRIPTION

When an IPv6 or Dual-stack terminal connects to the network, it will get router advertisements from the network that informs the terminal about which IPv6 prefix to use. According to an embodiment of the invention, a default route can be announced in a router advertisement from the centralized anchor point. As this route is selected, the terminal IPv6 address will also be corresponding to the prefix announced by the centralized default router.

For embodiments of the invention based on the use of IPv6 prefixes, the selection is done by just looking at the source address as the terminal will in fact make the address selection based on the advertised routes.

In order to identify services of applications in the terminal that are to be broken out at a local site, the DNS (Domain Name System) system is advantageously configured to identify the local services so that the device can select the proper source IP address and through that allow for break-out of the services at the distributed site (close to radio access). This can be done by either re-using the same IP prefix for all distributed services, independently of where they are allocated (often called IP Anycasting as the service may be served by any server in the network). When no distributed site exists that can terminate that traffic it needs to be served by the central site instead. Whether to break-out traffic on a distributed site or not is then determined by the IP-prefix announcements in the neighbour discovery procedure (router advertisements according to RFC 4191 and RFC 4861).

Another alternative according to an embodiment of the invention is to provide services that different IP addresses depending on location (what local site to access). In this case, the DNS service needs to be configured according to location. This can be done in at least two ways, either there is a local DNS (with an Anycast address as it need to be the same IP address for the DNS server independent of where the server is located) on the breakout site that handles all DNS queries and uses the DNS infrastructure to answer DNS queries for host names not configured in the local DNS. Another alternative is that the DNS queries are intercepted and modified in the network to add information to them about location. This can be done when CDN services are used for services that are not bound to a specific network, e.g. for mobile terminals that may access the network. One solution is to have a CNAME (Canonical Name)-record that points out a new URL that is specific for the location that one accesses. The CNAME record has a very short lifetime (a few seconds) and may give different answers depending on location in the network. This would imply that the DNS queries for these services are then answered with a DNS answer that is based on the location of the device and that the IP anchor functionality can include a DNS server that answers the request and includes the location information in the new DNS name(s) to query for or that the query is modified to include the location information before it is served by an external DNS server. As services that could be identified for breakout in the network are under operator control (known IP prefixes), for some embodiments it shall be enough to support only IPv6 even if devices are also supporting IPv4. Since most major services on the internet have currently IPv6 support, this would cause few drawbacks.

A solution according to an embodiment of the invention can support both IPv6 only devices as well as dual stack devices.

IPv4-only based services may also be used for embodiments of the invention by e.g. applying the 464XLAT (RFC6877) concept, either in the terminal as Android devices are doing already today, or according to the solution described in WO 2015/173287 A1 with the first part of the NATing (Network Address Translation) in the termination point of the tunnel (in this case the distributed site). For the 464XLAT solution to work, a DNS64 need to be configured to support the functionality, just like it need to be done for the name lookup to find the local services without NATing, i.e. with native IPv6.

When the terminal moves out of an area covered by a distributed site, the dedicated IP address needs to be removed from the terminal. One can let it time out as a router advertisement has an announced lifetime and the last gateway in the chain may send ICMP (Internet Control Message Protocol) messages (destination/network unreachable messages) that forces the host to do new address resolution and select a new route via a new router. When this happens, the terminal is according to the RFCs supposed to probe the router that is down. An example of this shall be done is given in section 3.6 in RFC 4191. In that RFC is also a description on how to use the router preferences when failing over routes, which can be used in such a scenario as well.

According to an embodiment of the invention the break-out/tap of traffic is done based on IP addresses used as these can be selected based on the destination IP prefixes. The functionality is provided in a way that it is not affecting the reachability and availability of the more central IP anchor, any session using the services provided by the central IP anchor are not impacted at all by the services broken out during mobility. Only broken-out services may be impacted during mobility.

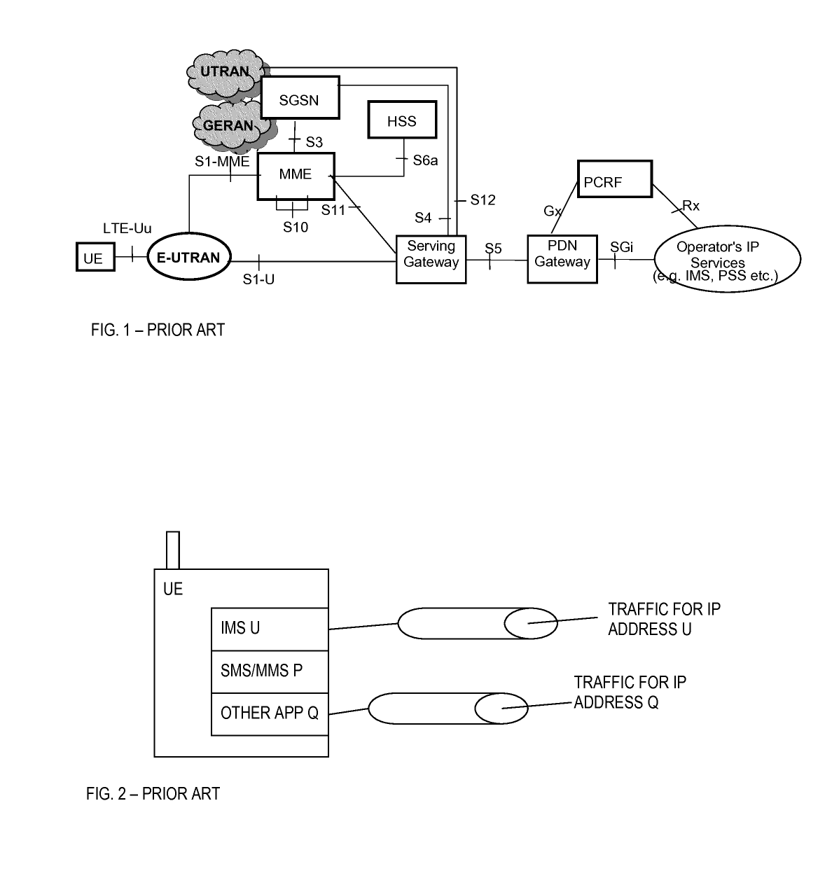

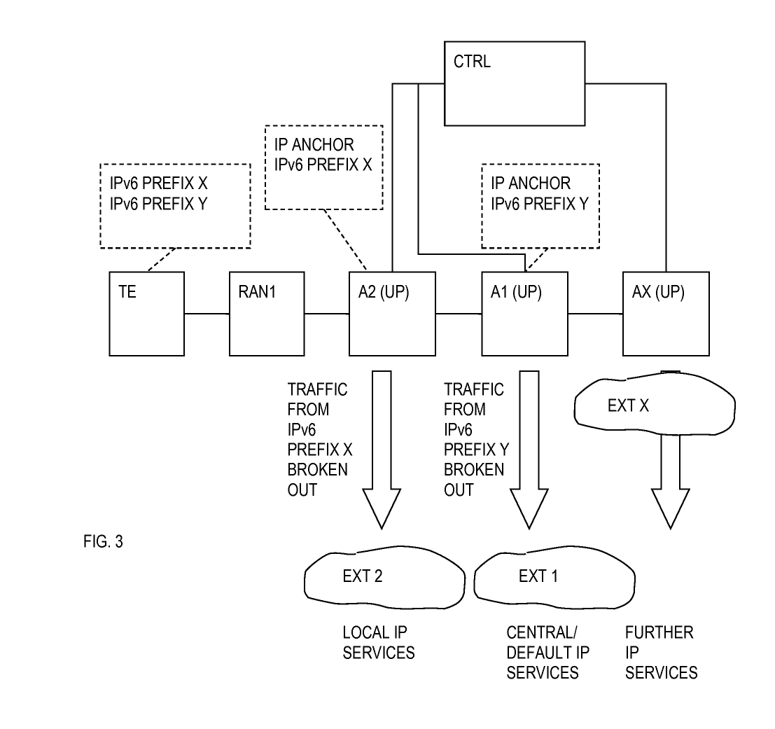

In FIG. 3, an embodiment of the invention is shown of a IPv6 based network according to the invention having core functionalities similar to the prior art network shown in FIG. 1. A user plane is provided for routing and transporting payload data from a terminal, TE, a radio access node, RAN1, a first—central—gateway node A1, a second more local serving node, A2 and further gateway node AX.

A control plane node, CTRL, controls the various serving nodes A2, A1 and AX via command messages over specific interfaces.

According to an embodiment of the invention the first user plane node A1 such as a gateway node that is adapted for communicating traffic to an external IP network or cloud, EXT1, which could provide central and default services. The second user plane node A2, that may be seen as a serving node, provides IP services for a second external IP network or cloud, EXT2, that could relate to local services relating to a geographical defined area in the vicinity of RAN1 or just to services not provided by the first network or cloud, EXT1. Still further services could be adapted to be provided via a still further user plane node AX cloud; EXT X. The breakout in central A1 may constitute a default route or the break out in local A2 may constitute the default route.

According to this embodiment, two IPv6 prefixes—IPv6 prefix X and IPv6 prefix Y—are allocated to specific applications in the terminal. The IPv6 prefixes may be arbitrarily allocated by the terminal for a given IPv6 address. In other words, at least two IPv6 prefixes are provided for the terminal network interface. A first central IP anchor is established in user plane node A1 while a second IP anchor is provided in user plane node A2. The first IP anchor may be provided in terms of a relatively lengthy or rather permanent first time period, while the second anchor may be arranged for a shorter second period of time and particular in dependency of the association to the particular radio access node with which the terminal is currently associated. At times, there may not be a second IP anchor denoted by IPv6 prefix X for the terminal.

According to embodiments of the invention, IP traffic stemming from IPv6 prefix X is broken out in node A2 towards external network EXT2, while IP traffic stemming from IPv6 prefix Y is broken out in node A1 towards external network EXT1.

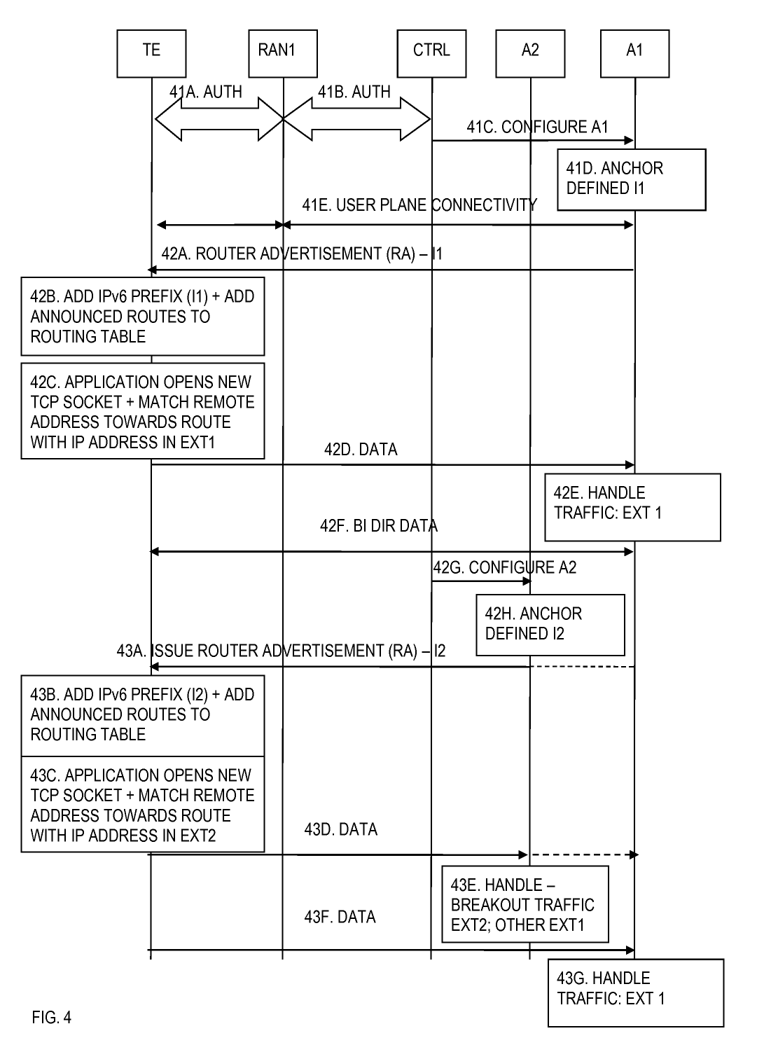

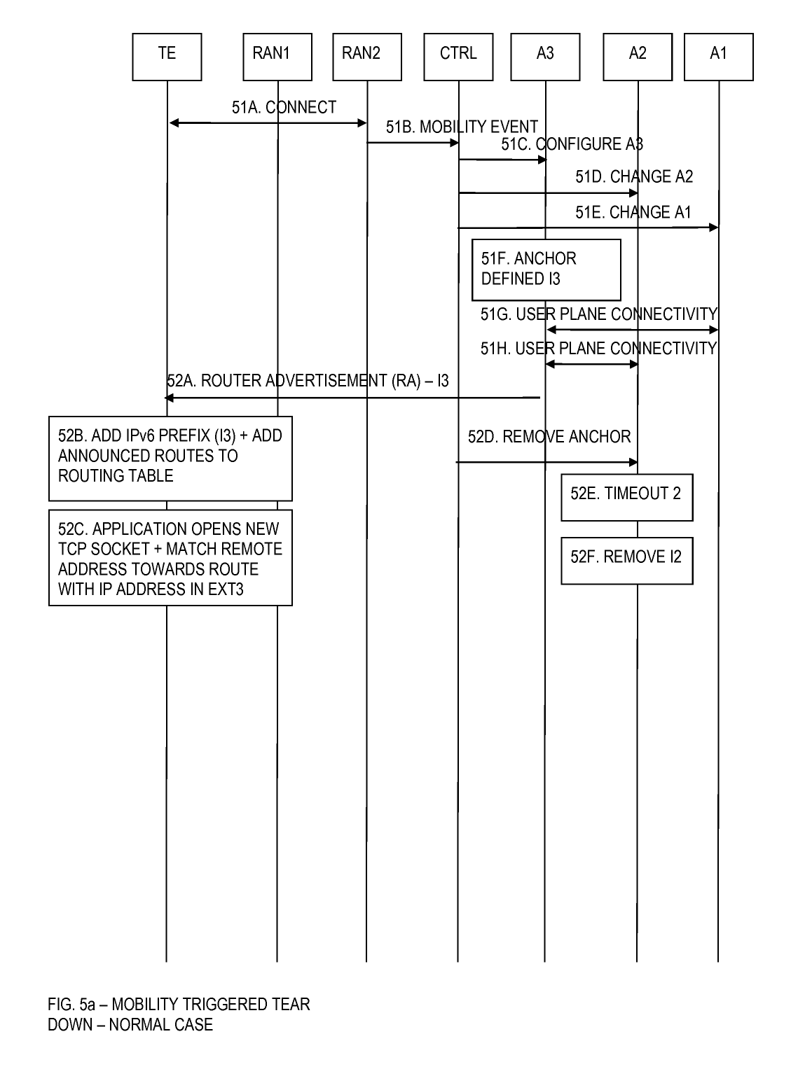

In FIG. 4, a first embodiment of a method according to the invention is shown for initially setting up two anchors on a session and establishing a local break out point.

In step 41A and 41B, authentication of the terminal TE is performed before the radio access node RAN1 and the control node CTRL. The control node subsequently configures, 41C, IP connectivity in the central node A1 by issuing a Configure message towards node A1.

In step 41D, an IPv6 anchor is established in the central user plane node A1 and a user plane connectivity 41E is established between the user plane node A1 and the radio access node RAN1 and between the radio access node RAN1 and the terminal TE.

The user plane node A1 issues in step 42A a Router Advertisement (RA)—comprising the IPv6 prefix, denoted I1—over the user plane to the terminal TE.

When the terminal receives the RA message in step 42B, the terminal adds the IPv6 prefix, I1, and adds the announced routes to a routing table.

In step 42C, an application in the terminal TE opens a new Transmission Control Protocol, TCP socket and matches the remote address towards a route with an IP address in EXT1.

Data is transmitted from the terminal, c.f. step 42D, is subsequently received in user plane node A1 which in step 42E handles the traffic and forwards the traffic to the external cloud or IP first external network EXT 1.

In step 42F, bidirectional data is communicated between the terminal and A1.

The control plane node CTRL triggers in step 42G a configuration of A2 which in step 42H defines an IP anchor I2.

Now, the user plane node A2 issues in step 43A Router Advertisement (RA)—comprising the IPv6 prefix, denoted —I2.

Then follows similar steps to what is explained under 42B and 42C.

In step 43B, the terminal adds the IPv6 prefix (I2) and adds the announced routes to routing table.

In step 43C, the application opens a new TCP socket and matches the remote address towards a route with an IP address in EXT2.

In step 43D and 43F data, is transmitted from the terminal.

Insofar data originates from IPv6 prefix X data, step 43D, the data is handled 43E such that it is broken out in A2 and routed to EXT2 as shown in FIG. 3. On the other hand, if data originates from IPv6 prefix Y, data is routed to go further from A2 to A1, which again routes data further to EXT1 as also shown in FIG. 3. The latter step is shown in 43F Data.

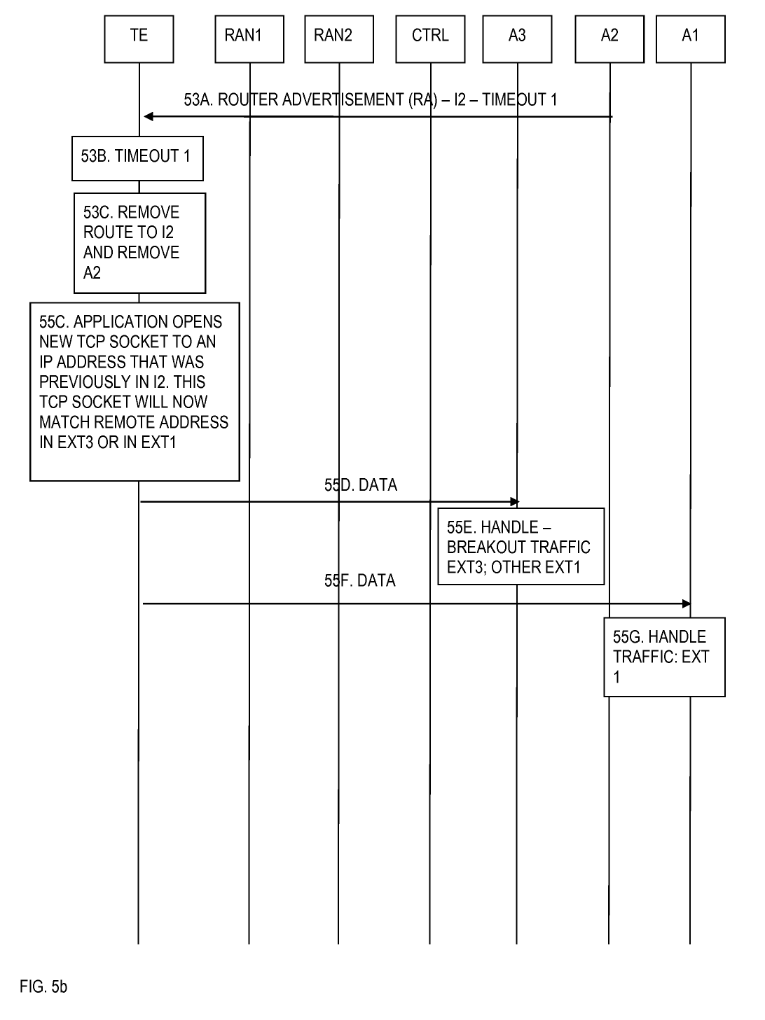

In FIG. 5a, a mobility triggered scenario with a move and a controlled tear-down of break out of traffic in A1 is illustrated whereby it should be understood that the previous steps of FIG. 4 have been undertaken. In other words, a first IP anchor is defined for A1 and a second IP anchor is defined for A2.

In step 51A, the terminal moves from the first radio access node RAN1 into the vicinity of a second radio access node RAN2 and experiences handover and connects to RAN2.

This mobility event is reported by RAN2 to the control plane node CTRL, 51B.

Since the user plane node A3 may be situated closer to the new RAN2, the control plane node transmits a configuration message in step 51C of A3 to A3 for initiating a change of break out point. The control plane node moreover issues information in step 51D of the change to A2, informing A2 that the former break out point is now in the process of being taken down in A2. The control plane node moreover issues information in step 51E of the change to A1.

When A3 receives the info of 51C it can now establish in step 51F an IP anchor for A3 defined by I3.

Then follows the set-up of—51G—user plane connectivity between A3 and A1 and—step 51H—user plane connectivity between A3 and A2.

The newly added user plane node for break out, A3, issues in step 52A a router advertisement (RA) including IPv6 prefix, I3, to the terminal TE informing about the new prefix for break out.

In step 52B, the terminal adds the new IPv6 prefix, I3, and adds the announced routes to the routing table.

In step 52C, the application opens a new TCP socket and matches the remote address towards a route with the IP address in Ext3.

The control plane node CTRL issues in step 52D a remove anchor message to A2.

In step 52E, a timer Timeout 2 is set which upon expiration causes the node A2 to remove its specific IP handling for I2 in step 52F.

In FIG. 5b the process of FIG. 5a continues.

Now in 53A, the previous breakout user plane node A2 issues Router Advertisement (RA)—I2 with a timer value Timeout 1.

Upon step 53B, timeout of Timeout 1,

The TE removes, 53C, the route to I2 and removes A2.

In step 55C, the application opens new TCP socket to an IP address that was previously in I2. This TCP socket will now match remote address in EXT3 or EXT1.

The application in the terminal opens a new TCP socket to the same destination as defined in step 52C and matches the remote address towards route with IP address in EXT3

Data can now when in step 55D received by A3 be handled by A3, step 55E, and made subject to either breakout of traffic towards EXT3 or EXT1, as explained above.

Data transmitted to A1, 55F, is handled, 55G, and may for instance be forwarded to EXT 1.

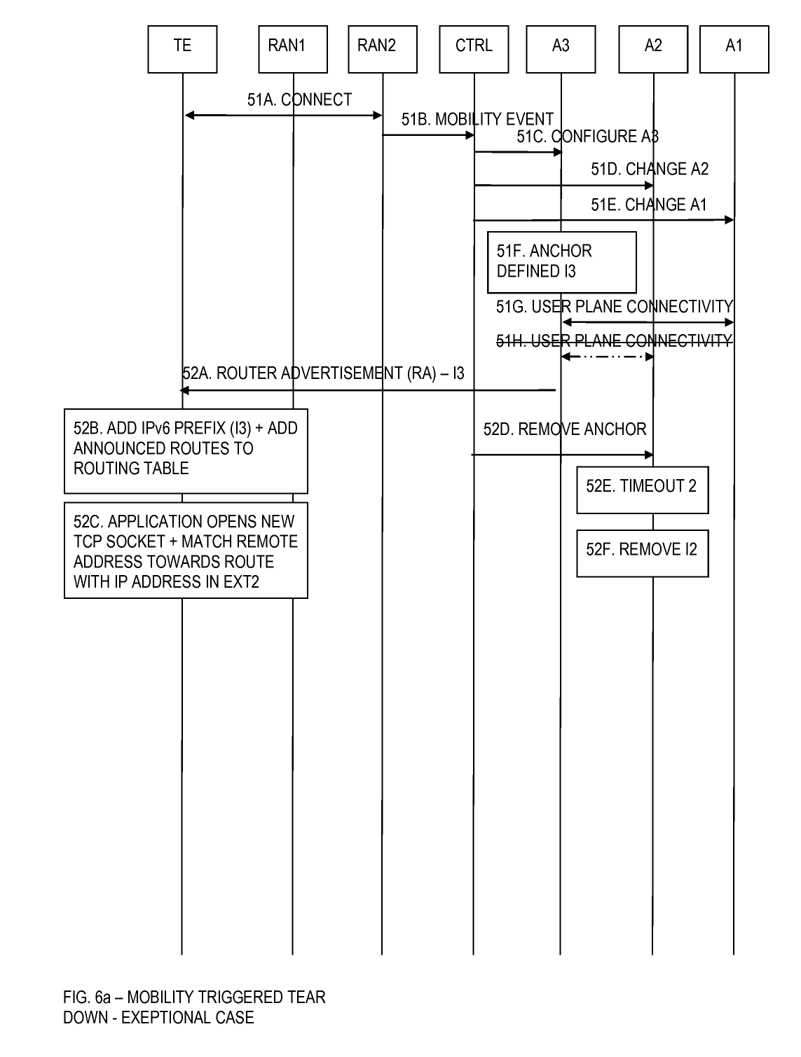

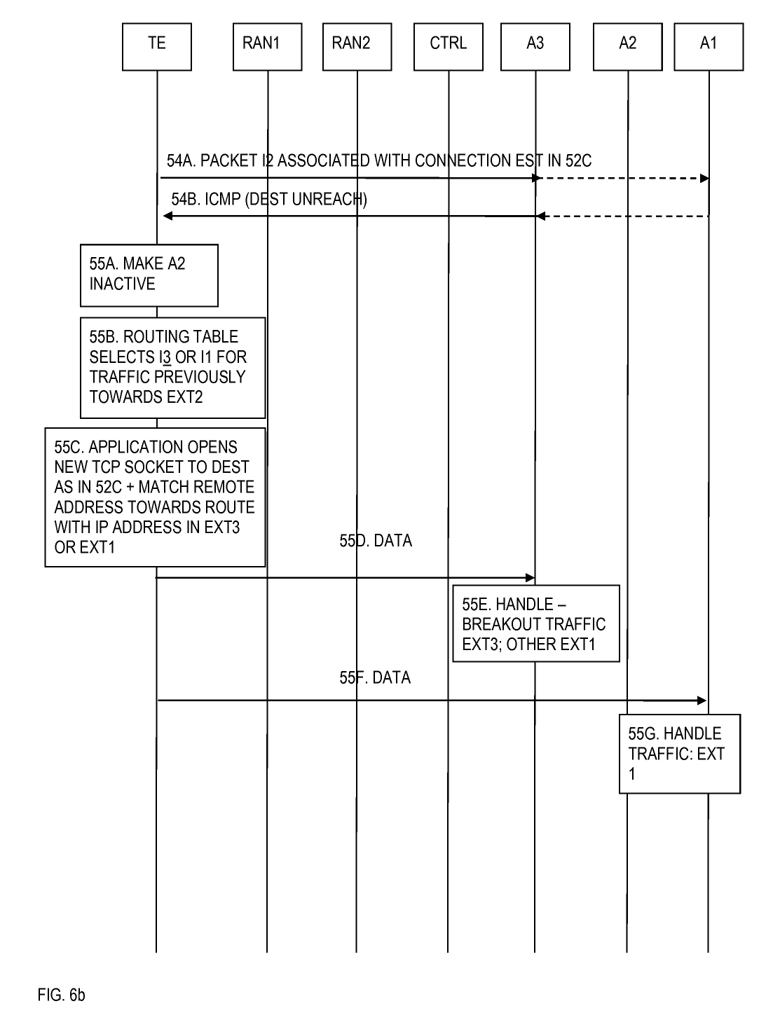

In FIG. 6a, a fault routine according to the invention is shown for the same scenario for a mobility triggered move and tear down of a break out point. This routine shall be closely explained with regard to the scenario of FIGS. 5a and 5b. In this presentation, the same steps, indicated with identical reference numbers, shall not be repeated. The mobility scenario is similar to the previous one explained in FIGS. 5a and 5b, but the embodiment is handling an unexpected (or expected) loss of A1 (e.g. due to no tunnel possibilities between A1 and A3).

In comparison to the procedure shown in FIG. 5a, the step 51H action/signal is not provided/happening (and therefore shown in strikethrough—the lack of the signal being indicated by dashed line in the figure): Step—51H, user plane connectivity is not established between A2 and A3.

Apart from this the scenario in FIG. 6a is the same as in FIG. 5a.

A3 was made aware of the new break out and A3 issues in 52A a Router Advertisement (RA)—with I3. (This may also be done by A1, depending on the implementation choices for the control node) that it needs to remove announcements for anchor A1.

In FIG. 6b, the process continues.

For the situation that a packet with I2 associated with the connection established from the procedure in step 52C is issued 54A from the terminal TE towards new user plane node A3 or the old user plane A1, the respective receiving node A3/A1 issues in step 54B an ICMP (Destination Unreach) signal informing about the unreachability of I2.

If the terminal subsequently receives signal 54B, the terminal makes I2 inactive in step 55A.

In step 55B, the routing table selects I3 or I1 for traffic previously towards EXT2.

In step 55C, the application opens new TCP socket to destination as in 52X and matches the remote address towards route with IP address in EXT3 or EXT1.

Then follows Step 55D—data from TE to A3: handle traffic—breakout traffic EXT3; handle other traffic to EXT1.

For data 55F issued to A1, step 55G. traffic is handled to EXT1.

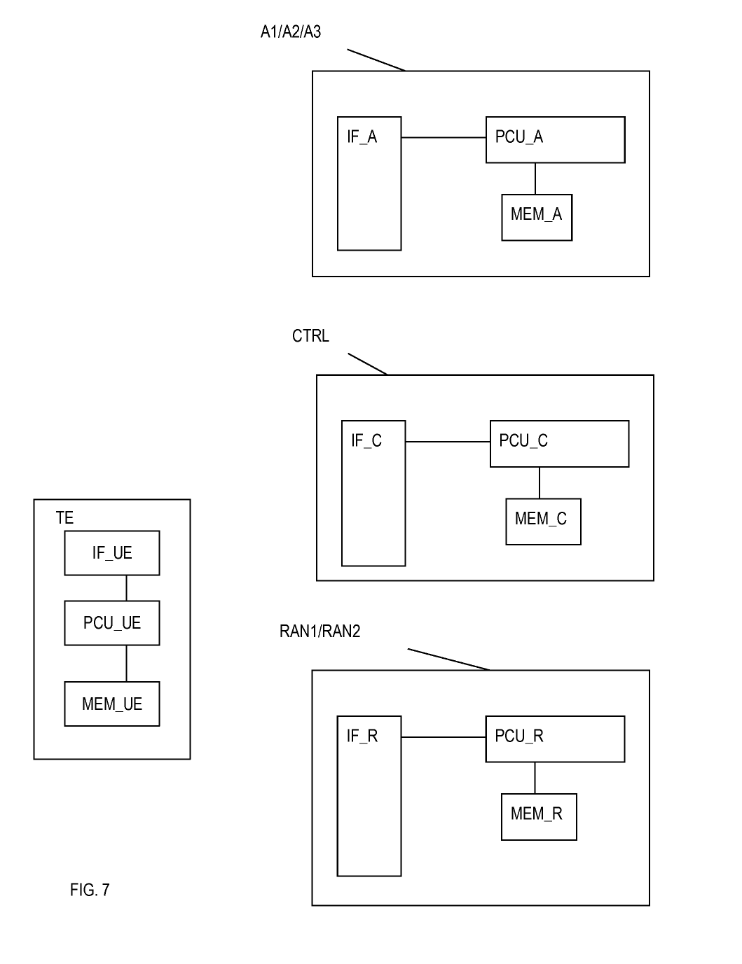

In FIG. 7, is shown an apparatus user plane node, either being node A1, node A2 and node A3.

The apparatus comprises a processor PCU_A, an interface IF_A and a memory, MEM_A. In the memory instructions are stored for carrying out the process steps shown above with relation to FIGS. 3, 4, 5a+b and 6a+b. The processor carries out the instructions.

There is moreover shown a control node CTRL comprising a processor PCU_C, an interface IF_C; and a memory, MEM_C. Instructions are stored in the memory for being performed by the processor and effectuated on the interface for carrying out the process steps shown above with relation to FIGS. 3, 4, 5a+b and 6a+b.

In FIG. 7, there is also shown a terminal, TE, such as a user equipment, UE, apparatus according to the invention. The TE comprises a processor PCU_UE an interface IF_UE and a memory, MEM_UE, in which memory instructions are stored and for carrying out the method steps explained above. The UE communicates via the interface IF_UE. The IF_UE comprises both an external interface, communicating with a transmitter and receiver, and internal interfaces (not shown).

Finally, a radio access node, RAN1, RAN2 is shown comprising a processor PCU_R, an inter-face IF_R; and a memory, MEM_R. Instructions are stored in the memory for being per-formed by the processor and effectuated on the interface for carrying out the process steps shown above with relation to FIGS. 3, 4, 5a+b and 6a+b.

The above apparatuses/entities are adapted to communicate over known external telecom interfaces or via application programming interfaces as appropriate.

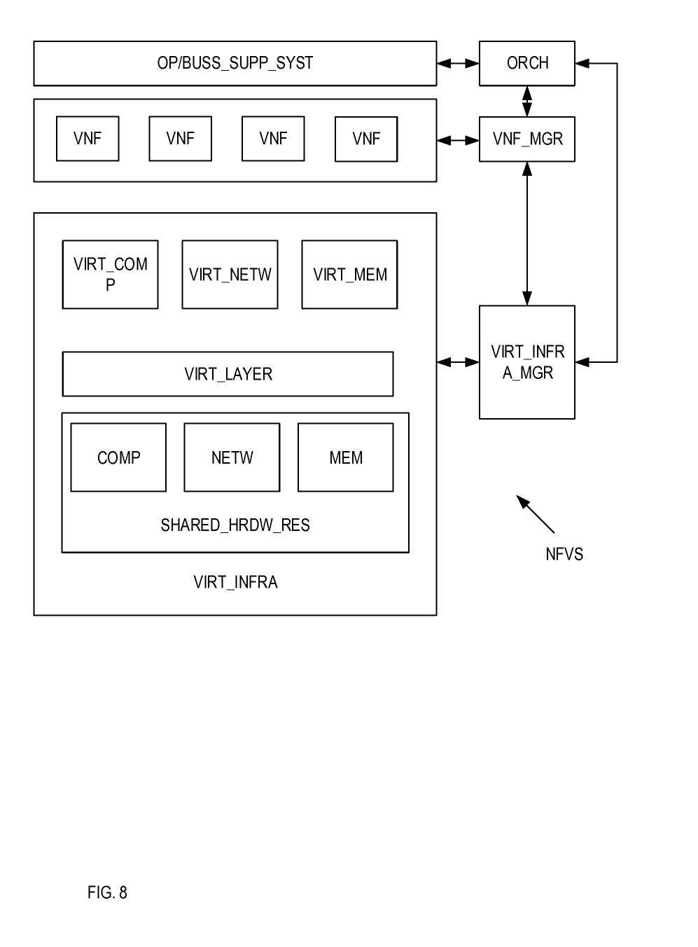

The methods discussed above may alternatively be implemented by means of a system based on network functions virtualization. In FIG. 8, further embodiments of the invention are implemented by means of such a network function virtualization system, NFVS, formed on e.g. general purpose servers, standard storage and switches. The NFVS may be arranged along the lines described in FIG. 4, ETSI GS NFV 002 V. 1.1.1 (2013-10) and comprises the following elements: A NFV management and orchestration system comprising an Orchestrator, ORCH, a VNF manager, VNF_MGR, and a virtualised Infrastructure manager, VIRT_INFRA_MGR. The NFVS moreover comprises an operational/business support system, OP/BUSS_SUPP_SYST; a number of virtual network function instances, VNF, by which the method steps explained above are instantiated; and a virtualised infrastructure, VIRT_INFRA. The VIRT_INFRA comprises a virtual computing, VIRT_COMP, virtual network; VIRT_NETW, and virtual memory, VIRT_MEM, a virtualisation layer, VIRT_LAYER, (e.g. hypervisor) and shared hardware re-sources, SHARED_HARDW_RES comprising computing devices, COMP, network devices, NETW, comprising e.g. standard switches and other network devices, and standard data storage devices, MEM.

To emphasize particular embodiments of the invention, the following is provided:

System comprising a user plane for routing and transporting payload data and a control plane, the system comprising:

A terminal TE, a radio access node, RAN1 a first user plane node A1 connecting to a first external network EXT1, a second user plane node A2 connecting to a second external network EXT2,

A control plane node CTRL for controlling the first A1 and the second A2 user plane nodes, the system being adapted for
configuring 41C, 41D; 42G, 42H a first IPv6 prefix Y and a second IPv6 prefix X,
forwarding 42C, 42E IP traffic stemming from the first IPv6 prefix Y in the second user plane node A2 towards the first user plane node A1 and further towards the first external network EXT1,
breaking out 43C, 43E IP traffic stemming from the second IPv6 prefix X in the second user plane node A2 towards the second external network EXT2.

The terminal TE may be further adapted for
authenticating 41A, 41B before a first radio access node RAN1 and the control node CTRL,
   the control plane node CTRL being adapted for
triggering 41C a configuration of the second user plane node A1,

The first node A1 may be adapted for
defining an IP anchor 41D in the first node A1,
issuing 42A a first router advertisement including the first IPv6 prefix Y to the terminal TE, wherein the triggering 41C of the configuration of the second user plane node A1 and the defining of an IP anchor 41D in the first node A1 constitutes the configuring 41C, 41D; 42G, 42H of the first IPv6 prefix Y and the second IPv6 prefix X.

The terminal when receiving the first router advertisement 42, comprises the action of
adding 42B the first IPv6 prefix, I1, and adding the announced routes to a routing table; whereby
   an application in the terminal TE, is
opening 42C a TCP socket and matching the remote address towards a route with an IP address in first external network EXT1.

The control plane node CTRL may be
triggering 42G a configuration of the second user plane node A2,
   whereby the second user plane node A2 may be
defining 42H subsequently a second IP anchor I2 and
issuing 43A a second router advertisement, RA, including the second IPv6 prefix X to the terminal TE.

The terminal may be further adapted for when receiving the second router advertisement 42,
adding 42B the second IPv6 prefix I2 and adding the announced routes to a routing table; an application in the terminal TE,
opening 43C a new TCP socket and matching the remote address towards a route with an IP address in the second external network EXT2.

When the control plane node is
receiving 51B a mobility event report related to a handover of the terminal TE from the first radio access node RAN1 to a second radio access node RAN2, the control plane node
configuring 51C a third user plane node A3 for change of break out point,
issuing information 51D to the second user plane node A2 that the former break out point being in the process of being taken down in the second user plane node A2,
issuing information 51E about the change of break out point to the first user plane node A1;
   the third user plane node A3 being adapted for
defining 51F an IP anchor I3,
setting up 51G a user plane connectivity between the third node A3 and the first node A1,
setting up 51H a user plane connectivity between the third node A3 and the second node A2,
   the terminal TE being adapted for
adding a third IPv6 prefix I3 and adding the announced routes to the routing table, an application in the terminal T,
opening 52B a new TCP socket and matching 52C the remote address towards a route with an IP address in the third external network EXT3.

The control plane node CTRL being adapted for
issuing 52D a remove anchor message to the second node A2.

The second user plane node A2 being adapted for
issuing Router Advertisement, RA, I2 with a timer value Timeout 1 to the terminal TE, the terminal, upon timeout 53B of timer value Timeout 1,
removing 53C the route to I2 and removing the second node A2,
opening 55C a new TCP socket to an IP address that was previously in I2, the TCP socket matching the remote address in the third external network EXT3 or the first external network EXT1,
   the third node A3
making data subject to either breakout 55E of traffic towards the third external network EXT3 or 55G of the first external network EXT1.

The first IPv6 prefix Y and the second IPv6 prefix X may be allocated to respective applications in the terminal, the first IP anchor is denoted by the first IPv6 prefix Y for the terminal, and the second IP anchor is denoted by the second IPv6 prefix X for the terminal.

There is also envisioned a user plane node A2 being adapted for
forwarding 42C, 42E IP traffic stemming from the first IPv6 prefix Y in the second user plane node A2 towards the first user plane node A1 and further to-wards the first external network EXT1,
breaking out 43C, 43E IP traffic stemming from the second IPv6 prefix X in the second user plane node A2 towards the second external network EXT2.

Further a terminal TE is provided on which at least an application is running, the terminal being adapted for
receiving 42A a router advertisement from a first node A1 including a first IPv6 address,
adding 42B the IPv6 prefix I1,
adding the announced routes to a routing table,
   for an application in the terminal TE,
opening 42C a new TCP socket and matching a remote address towards a route with an IP address in a first external network EXT1.

A Control plane node is provided and adapted for
triggering 41C a configuration of the second user plane node A1, when the control plane node is
triggering 42G a configuration of the second user plane node A2,

The control plane node may be further adapted for
receiving 51B a mobility event report related to a handover of the terminal TE from the first radio access node RAN1 to a second radio access node RAN2, the control plane node
configuring 51C a third user plane node A3 for change of break out point,
issuing information 51D to the second user plane node A2 that the former break out point being in the process of being taken down in the second user plane node A2,
issuing information 51E about the change of break out point to the first user plane node A1.

### Further Embodiments

System comprising a user plane for routing and transporting payload data and a control plane, the system comprising

a terminal TE, a radio access node, RAN1 a first user plane node A1 connecting to a first external network EXT1, a second user plane node A2 connecting to a second external network EXT2,
a control plane node, CTRL for controlling the first A1 and the second A2 user plane nodes, the system being adapted for
configuring a first IPv6 prefix Y and a second IPv6 prefix X,
forwarding IP traffic stemming from the first IPv6 prefix Y in the second node A2 towards the first user plane node A1 and further towards the first external network EXT1,
breaking out IP traffic stemming from the second IPv6 prefix X in the second user plane node A2 towards the second external network EXT2.

A method for a network comprising a user plane for routing and transporting payload data and a control plane, the system comprising

a terminal TE, a radio access node, RAN1 a first user plane node A1 connecting to a first external network EXT1, a second user plane node A2 connecting to a second external network EXT2,
a control plane node, CTRL for controlling the first A1 and the second A2 user plane nodes, the method comprising
configuring a first IPv6 prefix Y and a second IPv6 prefix X,
forwarding IP traffic stemming from the first IPv6 prefix Y in the second node A2 towards the first user plane node A1 and further towards the first external network EXT1,
breaking out IP traffic stemming from the second IPv6 prefix X in the second user plane node A2 towards the second external network EXT2.

User plane node A2 being adapted for
forwarding IP traffic stemming from IPv6 prefix Y in the second node A2 towards the first user plane node A1 and further towards the first external network EXT1,
breaking out IP traffic stemming from the second IPv6 prefix X in the second user plane node A2 towards the second external network EXT2.

Method for a user plane node A2 comprising
forwarding IP traffic stemming from IPv6 prefix Y in the second node A2 towards the first user plane node A1 and further towards the first external network EXT1,
breaking out IP traffic stemming from the second IPv6 prefix X in the second user plane node A2 towards the second external network EXT2.

1-28. (canceled)

29. A system comprising a user plane for routing and transporting payload data, the system comprising:
a terminal;
a radio access node;
a first user plane node connecting to a first external network; and
a second user plane node connecting to a second external network,
wherein the system is configured to:
configure a first IPv6 prefix and a second IPv6 prefix;
forward IP traffic stemming from the first IPv6 prefix in the second user plane node towards the first user plane node and further towards the first external network; and
break out IP traffic stemming from the second IPv6 prefix in the second user plane node towards the second external network,
wherein the system further comprises:
a control plane; and
a control plane node for controlling the first and the second user plane nodes,
wherein:
the terminal is configured to:
authenticate before a radio access node and the control plane node;
the control plane node is configured to:
trigger a configuration of the first user plane node;
the first user plane node is configured to:
defining a first IP anchor in the first user plane node; and
issue a first router advertisement including the first IPv6 prefix to the terminal,
wherein the triggering of the configuration of the first user plane node and the defining of the first IP anchor in the first user plane node constitutes the configuring of the first IPv6 prefix, and
wherein the control plane node is further configured to:
trigger a configuration of the second user plane node;
the second user plane node:
defining a second IP anchor in the second user plane node; and
issuing a second router advertisement including the second IPv6 prefix to the terminal,
wherein the triggering of the configuration of the second user plane node and the defining of the second IP anchor in the second user plane node constitutes the configuring of the second IPv6 prefix; and
wherein the control plane node is further configured to:
receive a mobility event report related to a handover of the terminal from the first radio access node to a second radio access node, the control plane node, and in response thereto to perform:
configuring a third user plane node for change of break-out point;
issuing information to the second user plane node that the former break-out point is in the process of being taken down in the second user plane node; and
issuing information about the change of break-out point to the first user plane node.

30. The system according to claim 29, wherein the terminal, when receiving the first router advertisement, is configured to:
add the first IPv6 prefix, and add the announced routes to a routing table,
and wherein an application in the terminal is configured to:
open a Transmission Control Protocol socket and match the remote address towards a route with an IP address in the first external network.

31. The system according to claim 30, wherein the terminal is further configured to, when receiving the second router advertisement:
add the second IPv6 prefix and add the announced routes to a routing table;
and wherein an application in the terminal is configured to:
open a new Transmission Control Protocol socket and match the remote address towards a route with an IP address in the second external network.

32. System according to any of claim 29, wherein:
the third user plane node is further configured to:
define a third IP anchor; and
set up a user plane connectivity between the third node and the first user plane node,
the terminal is configured to:
add a third IPv6 prefix and adding the announced routes to the routing table; and
an application in the terminal is configured to:
open a new Transmission Control Protocol (TCP) socket and matching the remote address towards a route with an IP address in the third external network.

33. The system according to claim 32,
the control plane node being adapted for
issuing a remove anchor message to the second user plane node.

34. The system according to claim 33, wherein:
the second user plane node is configured to:
issue a Router Advertisement with a timer value to the terminal;
the terminal, upon timeout of timer value, is configured to:
remove the route to the second IP anchor and remove the second user plane node; and
open a new TCP socket to an IP address that was previously in the second IP anchor, the TCP socket matching the remote address in the third external network or the first external network; and
the third node is configured to:
make data subject to either break-out of traffic towards the third external network or of the first external network.

35. The system according to claim 29, wherein:
the first IPv6 prefix and the second IPv6 prefix are allocated to respective applications in the terminal;
the first IP anchor is denoted by the first IPv6 prefix for the terminal; and
the second IP anchor is denoted by the second IPv6 prefix for the terminal.

36. A second user plane node comprising:
a user plane for routing and transporting payload data; and
a control plane,
wherein the second user plane node is in a system that comprises:
a terminal;
a radio access node; and
a first user plane node connecting to a first external network,
the second user plane node connects to a second external network,
wherein the system further comprises a control plane and a control plane node for controlling the first and the second user plane nodes,
wherein:
the second user plane node is configured to:
forward IP traffic stemming from the first IPv6 prefix in the second user plane node towards the first user plane node and further towards the first external network; and
break out IP traffic stemming from the second IPv6 prefix in the second user plane node towards the second external network;
the second user plane node is further configured to:
define an IP anchor in the second user plane node; and
issue a router advertisement including the second IPv6 prefix to the terminal;
wherein:
the triggering of the configuration of the second user plane node and the defining of the IP anchor in the second user plane node constitutes the configuring of the second IPv6 prefix; and
the second user plane node is further configured to:
receive information in the second user plane node from the control plane node that the break-out point is in the process of being taken down in the second user plane node.

37. The second user plane node according to claim 36, configured to:
receive further information from the control plane node regarding removing the IP anchor in the second user plane node; and in response to:
remove the IP anchor in the second user plan node.

38. The second user plane node according to claim 36, further configured to:
issue a further router advertisement with a timer value to the terminal, upon the second user plane node having removed the IP anchor in the second user plane node, or
issue an Internet Control Message Protocol message with information destination unreachable.

39. A control plane node comprising:
a user plane for routing and transporting payload data; and
a control plane,
wherein the control plane node is in a system comprising:
a terminal;
a radio access node;
a first user plane node connecting to a first external network; and
a second user plane node connecting to a second external network,
wherein the system is adapted to:
configure a first IPv6 prefix and a second IPv6 prefix;
forward IP traffic stemming from the first IPv6 prefix in the second user plane node towards the first user plane node and further towards the first external network;
break out IP traffic stemming from the second IPv6 prefix in the second user plane node towards the second external network,
wherein the control plane node is configured to:
trigger a configuration of the first user plane node, wherein a first IP anchor in the first user plane node is defined such that the first user plane node can issue a first router advertisement including the first IPv6 prefix to the terminal,
wherein the triggering of the configuration of the first user plane node and the defining of the first IP anchor in the first user plane node constitutes the configuring of the first IPv6 prefix, and
the control plane node is further configured to:
trigger a configuration of the second user plane node, wherein a second IP anchor in the second user plane node is defined such that the second user plane node can issue a second router advertisement including the second IPv6 prefix to the terminal, wherein the triggering of the configuration of the second user plane node and the defining of the second IP anchor in the second user plane node constitutes the configuring of the second IPv6 prefix; and
receive a mobility event report related to a handover of the terminal from the first radio access node to a second radio access node, and in response thereto to:
configure a third user plane node for change of break-out point;
issue information to the second user plane node that the former breakout point is in the process of being taken down in the second user plane node; and
issue information about the change of break-out point to the first user plane node.

40. A method for a system comprising a user plane for routing and transporting payload data, the system comprising a terminal, a radio access node, a first user plane node connecting to a first external network, and a second user plane node connecting to a second external network, the method comprising:
configuring a first IPv6 prefix and a second IPv6 prefix;
forwarding IP traffic stemming from the first IPv6 prefix in the second user plane node towards the first user plane node and further towards the first external network; and
breaking out IP traffic stemming from the second IPv6 prefix in the second user plane node towards the second external network,
wherein the system further comprises a control plane and a control plane node for controlling the first and the second user plane nodes,
wherein:
the terminal performs:
authenticating before a radio access node and the control plane node;
the control plane node performs:
triggering a configuration of the first user plane node;
the first user plane node performs:
defining a first IP anchor in the first user plane node; and
issuing a first router advertisement including the first IPv6 prefix to the terminal,
wherein the triggering of the configuration of the first user plane node and the defining of the first IP anchor in the first user plane node constitutes the configuring of the first IPv6 prefix,
the control plane node further performs:
triggering a configuration of the second user plane node,
the second user plane node performs:
defining a second IP anchor in the second user plane node; and
issuing a second router advertisement, RA, including the second IPv6 prefix to the terminal,
wherein the triggering of the configuration of the second user plane node and the defining of the second IP anchor in the second user plane node constitutes the configuring of the second IPv6 prefix,
wherein the control plane node further performs, when receiving a mobility event report related to a handover of the terminal from the first radio access node to a second radio access node, the control plane node:
configuring a third user plane node for change of break-out point;
issuing information to the second user plane node that the former break-out point being in the process of being taken down in the second user plane node; and
issuing information about the change of break-out point to the first user plane node.

41. A method for a second user plane node in a system comprising a user plane for routing and transporting payload data and a control plane, the system comprising a terminal, a radio access node, and a first user plane node connecting to a first external network, the second user plane node connecting to a second external network, wherein the system moreover comprises a control plane and a control plane node for controlling the first and the second user plane nodes,
the second user plane node method comprising:
forwarding IP traffic stemming from the first IPv6 prefix in the second user plane node towards the first user plane node and further towards the first external network;
breaking out IP traffic stemming from the second IPv6 prefix in the second user plane node towards the second external network;
defining an IP anchor in the second user plane node; and
issuing a router advertisement including the second IPv6 prefix to the terminal,
wherein the triggering of the configuration of the second user plane node and the defining of the IP anchor in the second user plane node constitutes the configuring of the second IPv6 prefix,
the second user plane node method further comprising:
receiving information in the second user plane node from the control plane node that the break-out point is in the process of being taken down in the second user plane node.

42. The method for the second user plane node according to claim 41, comprising:
receiving further information from the control plane node regarding removing the IP anchor in the second user plane node; and in response performing:
removing the IP anchor in the second user plan node.

43. The method for the second user plane node according to claim 41, comprising:
issuing a further router advertisement with a timer value to the terminal, upon the second user plane node having removed the IP anchor in the second user plane node, or
issuing an Internet Control Message Protocol message with information destination unreachable.

44. A method for a control plane node in a system comprising a user plane for routing and transporting payload data and a control plane, the system comprising a terminal, a radio access node, a first user plane node connecting to a first external network, and a second user plane node connecting to a second external network,
the method comprising:
configuring a first IPv6 prefix and a second IPv6 prefix;
forwarding IP traffic stemming from the first IPv6 prefix in the second user plane node towards the first user plane node and further to-wards the first external network;
breaking out IP traffic stemming from the second IPv6 prefix in the second user plane node towards the second external network;
triggering a configuration of the first user plane node, wherein a first IP anchor in the first user plane node is defined such that the first user plane node can issue a first router advertisement including the first IPv6 prefix to the terminal, wherein the triggering of the configuration of the first user plane node and the defining of the first IP anchor in the first user plane node constitutes the configuring of the first IPv6 prefix;
triggering a configuration of the second user plane node, wherein a second IP anchor in the second user plane node is defined such that the second user plane node can issue a second router advertisement including the second IPv6 prefix to the terminal, wherein the triggering of the configuration of the second user plane node and the defining of the second IP anchor in the second user plane node constitutes the configuring of the second IPv6 prefix;
receiving a mobility event report related to a handover of the terminal from the first radio access node to a second radio access node, and in response the control plane node performing:
configuring a third user plane node for change of break-out point;
issuing information to the second user plane node that the former break-out point is in the process of being taken down in the second user plane node; and
issuing information about the change of break-out point to the first user plane node.
